(19) United States
(12) Patent Application Publication
(10) Pub. No.: US 2012/0189888 A1
(43) Pub. Date: Jul. 26, 2012

(54) BATTERY CELL OF A LITHIUM ION BATTERY

(75) Inventors: Yue Li Wang, Dongguan (CN); Kai Wu, Dongguan (CN)

(73) Assignee: Dongguan Amperex Technology Limited

(21) Appl. No.: 13/010,794

(22) Filed: Jan. 21, 2011

(51) Int. Cl. H01M 10/36

(52) U.S. Cl. 429/94

(57) ABSTRACT

A battery cell of a lithium ion battery includes a cathode plate and an anode plate spirally wounded together with a separator interposed therebetween. The cathode plate includes a cathode current collector and a cathode film containing cathode active material formed on the cathode current collector. The cathode current collector defines an exposed portion without cathode film formed thereon. The anode plate includes an anode current collector and an anode film containing anode active material formed on the anode current collector. Boundary of the exposed portion of the cathode current collector is formed with an insulatively isolating layer.

### FIELD OF THE PATENT APPLICATION

The present patent application generally relates to lithium ion batteries and, more specifically, relates to a battery cell of a lithium ion battery.

### BACKGROUND OF THE PATENT APPLICATION

With rapid development of science and technology, portable electronic devices, such as video cameras, laptop personal computers, portable DVDs and personal digital assistants are becoming increasingly popular in people's daily life. As a desirable power source for portable electronic devices, lithium ion batteries are widely used due to high energy density, high working voltage and long life span. Lithium ion batteries have gradually substituted other traditional batteries and been widely used in aircrafts, vehicles and medical equipments.

Typically, a lithium ion battery includes a number of battery cells connected to each other in series or in parallel. Referring to FIG. 1, a conventional battery cell of a lithium ion battery includes a cathode plate 12 and an anode plate 16 spirally wound together with a separator 14 disposed therebetween. The separator 14 is a micro porous film obtained via plasticization and extraction, which can maintain the electrolyte and insulatively separate the cathode plate 12 from the anode plate 16. The cathode plate 12 includes a cathode current collector 122 made from aluminum foil and a cathode film 124 containing cathode active materials formed on the cathode current collector 122. The anode plate 16 includes an anode current collector 162 of copper foil and an anode film 164 containing anode active material formed on the anode current collector 162.

During manufacturing of the lithium ion battery, a number of battery cells connected to each other in parallel or in serials are housed in a package. The electrolyte is filled into the package. At present, the electrolyte in the lithium ion batteries is generally combustible organic electrolyte. Therefore, special attention should be paid to the safety performance of the lithium ion battery.

However, during the manufacturing of the cathode current collector 122 and the anode current collector 162, metal particles possibly be introduced in the battery cell. Additionally, the aluminum cathode current collector 122 of the cathode plate 12 tends to form barb-shaped projections (hereinafter simply referred as cut burrs) on the cutting edge thereof in the manufacturing process. The cut burrs will potentially pierce through the separator 14 disposed between the cathode plate 12 and the anode plate 14, which will cause direct contact between the aluminum foil and the anode film 164 and, consequently, internal short circuit of the lithium ion battery. Due to the internal short circuit, the temperature in the lithium ion battery will rise quickly, which will potentially leads to the ignition of the organic electrolyte and even explosion of the lithium ion battery.

To avoid the occurrence of safety accidents, the aluminum foil of the cathode plate 12 is formed with adhesive tapes 18 on the areas which may contact the anode film 164, so as to insulatively separate the aluminum foil from the anode film 164 even though the separator 14 is damaged or pierced through. However, the adhesive tapes 18 can only be disposed manually and production efficiency of the lithium ion battery is undesirable.

What is needed, therefore, is to provide a battery cell of a lithium ion battery which has desirable safety performance and can be manufactured efficiently.

### SUMMARY OF THE PATENT APPLICATION

One object of the present patent application is to provide a battery cell of a lithium ion battery which has desirable safety performance and can be manufactured efficiently.

According to one embodiment of the present patent application, a battery cell of a lithium ion battery includes a cathode plate and an anode plate spirally wounded together with a separator interposed therebetween. The cathode plate includes a cathode current collector and a cathode film having cathode active material formed on the cathode current collector. The cathode current collector defines an exposed portion without cathode film formed thereon. The anode plate includes an anode current collector and an anode film having anode active material formed on the anode current collector. The anode current collector defines an exposed portion without anode film formed thereon. Boundary of the exposed portion of the cathode current collector or boundary of the exposed portion of the anode current collector, or the area of the anode film of the anode plate corresponding to the boundary of the exposed portion of the cathode current collector is formed with an insulatively isolating layer. Even though the separator is damaged or pierced through, the insulatively isolating layer can prevent the cathode current collector from contacting the anode film or the anode current collector.

The insulatively isolating layer can be coated on the cathode plate and/or the anode plate via coating equipment. No manual operation is needed. Therefore, production efficiency of the lithium ion battery can be remarkably improved.

Preferably, the insulatively isolating layer are simultaneously coated with the cathode film or the anode film.

Preferably, the insulatively isolating layer is a polymer layer containing oxide particles.

Preferably, the polymer of the insulatively isolating layer is selected from a group consisting of polyacrylic acid, polyvinylidene fluoride, styrene butadiene rubber and siloxane.

Preferably, the oxide particle in the insulatively isolating layer is selected from a group consisting of Al₂O₃, ZrO, SiO₂ and TiO.

Other advantages and novel features will be drawn from the following detailed description of preferred embodiments with the attached drawings. The accompanying drawings, which are incorporated in and constitute a part of this specification, illustrate embodiments of the present patent application and, together with a general description of the patent application given above, and the detailed description of the embodiments given below, serve to explain the principles of the patent application.

### BRIEF DESCRIPTION OF THE DRAWINGS

FIG. 1 depicts an exemplary cross-sectional view of a conventional battery cell; and

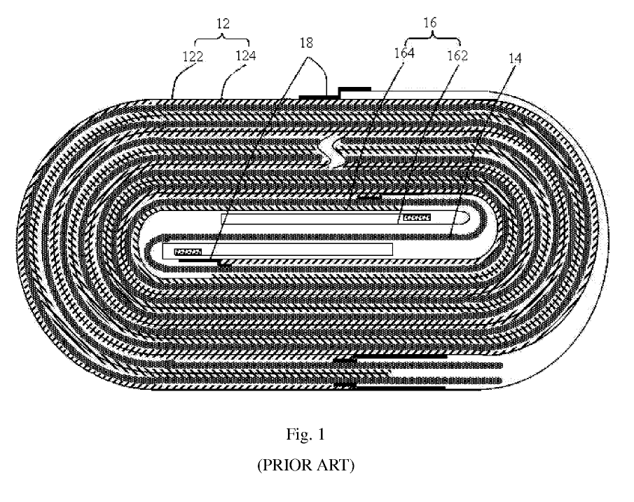

FIG. 2 depicts an exemplary cross-sectional view of a battery cell of a lithium ion battery according to one embodiment of the present patent application.

### DETAILED DESCRIPTION OF THE PATENT APPLICATION

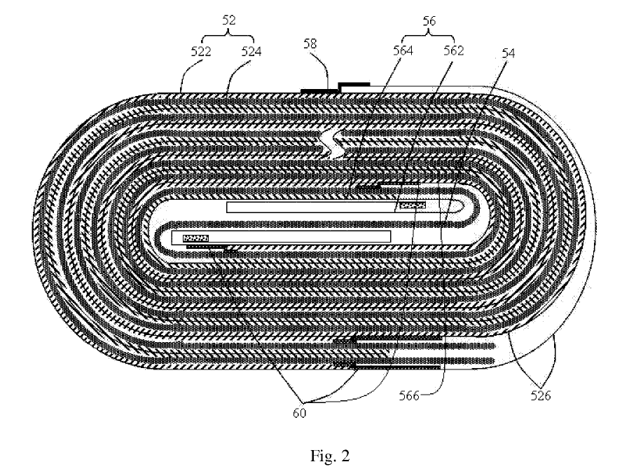

Referring to FIG. 2, a battery cell of a lithium ion battery according to one embodiment of the present patent application includes a cathode plate 52 and an anode plate 56 spirally wounded together with a separator 54 interposed therebetween. The separator 54 is disposed between the cathode plate 52 and the anode plate 56 to insulatively separate the cathode plate 52 from the anode plate 56 and maintain the electrolyte.

The cathode plate 52 includes a cathode current collector 522 of aluminum foil and a cathode film 524 containing cathode active material formed on one surface or two surfaces of the cathode current collector 522. The anode plate 56 includes an anode current collector 562 of copper foil and an anode film 564 containing anode active material formed on one surface or two surfaces of the anode current collector 562. The separator 54 is a micro porous film obtained via plasticization and extraction, which can maintain the electrolyte and electrically isolate the cathode plate 52 from the anode plate 56.

In the manufacturing process of the lithium ion battery, the cathode plate 52 and the anode plate 56 with the separator 54 interposed therebetween are spirally wound together to form a battery cell. The battery cell is packed in a battery pack foil and the electrolyte is filled.

As shown in FIG. 2, the cathode current collector 522 includes an exposed portion 526 without cathode film 524 formed thereon. The exposed portion 526 is formed on one surface or two surfaces of the cathode current collector 522. Boundary of the exposed portion 526 of the cathode current collector 522, i.e. the terminate boundary of the cathode film 524, is apt to forming cut burrs. The cut burrs may pierce through and damage the separator 54 and further contact the anode plate 56. To avoid safety accidents caused by damaged separator 54, according to one embodiment of the present patent application, boundary of the exposed portion 526 of the cathode current collector 522 is formed with a layer of insulatively isolating layer 60. The insulatively isolating layer 60 can prevent the cathode current collector 522 from contacting the anode film 564 and/or the anode current collector 562 even though the separator 54 is damaged or pierced through, so as to avoid internal short circuit in the lithium ion battery. According to one embodiment of the present patent application, the insulatively isolating layer 60 and the cathode film 524 are simultaneously coated on the cathode current collector 522 via coating equipments. In accordance with another embodiment of the present patent application, the insulatively isolating layer 60 and the anode film 564 are simultaneously coated on the anode current collector 562 via coating equipments.

The insulatively isolating layer 60 is a layer of polymer containing oxide particles. According to one embodiment of the present patent application, the polymer of the insulatively isolating layer 60 is selected from a group consisting of polyacrylic acid, polyvinylidene fluoride, styrene butadiene rubber (SBR) and siloxane. The oxide particle in the insulatively isolating layer 60 is selected from a group consisting of Al₂O₃, ZrO, SiO₂ and TiO.

According to another embodiment of the present patent application, the anode plate 56 is formed with an insulatively isolating layer 60 corresponding to the boundary of the exposed portion 526 of the cathode current collector 522. According to yet another embodiment of the present patent application, the insulatively isolating layer 60 is formed on the boundary of the exposed portion 566 of the anode film 564 on the anode current collector 562. According to the requirement of wounding or overlay of the cathode plate 52, the anode plate 56 and the separator 54, the insulatively isolating layer 60 can be formed on one surface or two surfaces of the cathode plate 52 or the anode plate 56. In a word, the insulatively isolating layer 60 is formed at the area of the battery cell where the separator 54 is apt to being pierced through, so as to prevent the aluminum foil cathode current collector 522 from contacting the anode film 564 and/or the anode current collector 562. Surely, the sites where the insulatively isolating layer 60 is formed should take the affect of the insulatively isolating layer 60 on the performance of the lithium ion battery, e.g. the ion conductivity into account.

In view of the previous description, the cathode plate 52 and the anode plate 56 of a battery cell according to one embodiment of the present patent application are coated with an insulatively isolating layer 60, which can remarkably reduce internal short circuit in the lithium ion battery. The insulatively isolating layer 60 is coated on the cathode plate 52 or the anode plate 56 via coating equipments. No manual operation is needed. Thus, production efficiency of the lithium ion battery can be remarkably improved.

It should be noticed that, although the production efficiency of the battery cell can be improved via replacing the adhesive tape 18 in the prior art with the insulatively isolating layer 60 as detailed in the present patent application, the adhesive tapes 18 which can be replaced are only those adhesive tapes 18 used to insulatively separate the cathode plate 52 from the anode plate 56. As shown in FIG. 2, the adhesive tapes 58 at the outside of the battery cell for fixing the battery cell still cannot be replaced by the insulatively isolating layer 60.

While the present patent application has been illustrated by the above description of the preferred embodiments thereof, while the preferred embodiments have been described in considerable detail, it is not intended to restrict or in any way to limit the scope of the appended claims to such details. Additional advantages and modifications within the spirit and scope of the present patent application will readily appear to those ordinary skilled in the art. Consequently, the present patent application is not limited to the specific details and the illustrative examples as shown and described.

What is claimed is:

1. A battery cell of a lithium ion battery, comprising:
a cathode plate and an anode plate spirally wounded together with a separator interposed therebetween,
the cathode plate comprising a cathode current collector and a cathode film containing cathode active material formed on the cathode current collector, the cathode current collector defining an exposed portion without cathode film formed thereon; and
the anode plate comprising an anode current collector and an anode film containing anode active material formed on the anode current collector, the anode current collector defining an exposed portion without anode film formed thereon;
wherein boundary of the exposed portion of the cathode current collector, boundary of the exposed portion of the anode current collector, and area on the anode film of the anode plate corresponding to the boundary of the exposed portion of the cathode current collector each is coated with an insulatively isolating layer containing polymer and oxide particles via coating equipments, to prevent the cathode current collector from contacting the anode film or the anode current collector even though the separator is damaged.

2. The battery cell of claim 1, wherein the insulatively isolating layer are simultaneously coated with the cathode film or the anode film.

3. The battery cell of claim 1, wherein the polymer of the insulatively isolating layer is selected from a group consisting of polyacrylic acid, polyvinylidene fluoride, styrene butadiene rubber and siloxane.

4. The battery cell of claim 1, wherein the oxide particle in the insulatively isolating layer is selected from a group consisting of Al₂O₃, ZrO, SiO₂ and TiO.

5. A battery cell of a lithium ion battery, comprising:
a cathode plate and an anode plate spirally wounded together with a separator interposed therebetween,
the cathode plate comprising a cathode current collector and a cathode film containing cathode active material formed on the cathode current collector, the cathode current collector defining an exposed portion without cathode film formed thereon; and
the anode plate comprising an anode current collector and an anode film containing anode active material formed on the anode current collector, the anode current collector defining an exposed portion without anode film formed thereon;
wherein boundary of the exposed portion of the cathode current collector, or boundary of the exposed portion of the anode current collector, or area on the anode film of the anode plate corresponding to the boundary of the exposed portion of the cathode current collector is formed with an insulatively isolating layer.

6. The battery cell of claim 5, wherein the insulatively isolating layer are simultaneously coated with the cathode film or the anode film.

7. The battery cell of claim 5, wherein the insulatively isolating layer is a polymer layer containing oxide particles.

8. The battery cell of claim 7, wherein the polymer of the insulatively isolating layer is selected from a group consisting of polyacrylic acid, polyvinylidene fluoride, styrene butadiene rubber and siloxane.

9. The battery cell of claim 7, wherein the oxide particle in the insulatively isolating layer is selected from a group consisting of Al₂O₃, ZrO, SiO₂ and TiO.
